(19) United States
(12) Patent Application Publication
(10) Pub. No.: US 2003/0203136 A1
(43) Pub. Date: Oct. 30, 2003

(54) Heat-sensitive recording material and heat-sensitive recording method

(75) Inventor: Koh Takeuchi, Shizuoka-ken (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/351,611

(22) Filed: Jan. 27, 2003

(30) Foreign Application Priority Data
Jan. 25, 2002 (JP) 2002-17506

(51) Int. Cl. B41M 5/30

(52) U.S. Cl. 428/32.6

(57) ABSTRACT

The invention provides a heat-sensitive recording material including, as a heat-fusible substance, a derivative of a higher fatty acid in which one or more hydrogen atoms in an alkyl group are replaced with hydroxyl groups, and a preferable derivative of the higher fatty acid is a derivative of 12-hydroxystearic acid. The invention also provides a heat-sensitive recording method, which includes the steps of applying thermal energy via a thermal head having an uppermost layer whose carbon content is 90% or higher, to a heat-sensitive recording material.

### BACKGROUND OF THE INVENTION

1. Field of the Invention

The present invention relates to a heat-sensitive recording material and a heat-sensitive recording method, and more specifically, to a heat-sensitive recording material and a heat-sensitive recording method capable of forming high-quality images that are suitable for medical recording media or the like.

2. Description of the Related Art

Heat-sensitive recording methods have recently expanded into various fields, being applied to recording in devices such as facsimile machines, printers, and label printers in point of sale (POS) equipment. These methods provide advantageous features such as (1) development being unnecessary; (2) the quality of the material being close to that of regular paper when the substrate is paper; (3) being easy to handle; (4) high color development, density; (5) the recording device being simple, highly reliable, and inexpensive; (6) being free of unwanted noise when recording; and (7) maintenance being unnecessary.

Examples of widely known conventional heat-sensitive recording materials include those utilizing a reaction between an electron-donating dye precursor and an electron-accepting compound, and those utilizing a reaction between a diazo compound and a coupler.

Given the above-described circumstances, there has been a recent demand to develop a transparent heat-sensitive recording material that enables direct recording using a thermal head in order to respond to the needs of multi-color imaging, which makes possible the projection of images using an overhead projector or the direct observation of images on a light table.

Hence, heat-sensitive recording materials have been proposed comprising a transparent substrate, such as a synthetic polymer film, having disposed thereon a heat-sensitive recording layer, characterized in that the heat-sensitive recording layer is formed by dispersing a substantially colorless color-developing component A and a substantially colorless color-developing component B capable of reacting with component A to form color in fine particles within a binder; or by micro-encapsulating either one of components A and B and formulating the non-encapsulated component into an emulsified product.

While such a heat-sensitive recording material exhibits sufficient transparency, it also possesses undesirable effects such as causing sticking or noises when printing is carried out using a heat-sensitive recording apparatus, such as a thermal printer. Particularly when a transparent heat-sensitive recording material is used for medical purposes, the thermal energy applied via the thermal head must be increased due to the high transmission density required for medical use. That increase in thermal energy aggravates problems such as sticking, unwanted noise when recording, or abrasion of the thermal head. In order to alleviate the sicking and noise problems, arrangement of a protective layer that is principally made of a pigment and a binder on the heat-sensitive recording layer, and further, incorporation of various lubricants in the protective layer, have been attempted.

When the heat-sensitive recording material is applied to medical uses, high-energy recording is performed so as to provide a high black area ratio, inevitably inducing abrasion of the thermal head. This in turn causes changes in the thermal conductivity from the heat-generating member of the thermal head, resulting in an unevenness of density. In order to cope with abrasion of the thermal head, disposition of a layer, that is, a layer principally made of carbon and thus very hard and chemically stable, on the surface of the head has been proposed.

However, a carbon layer is lower in surface energy when compared with the conventional thermal head surface layer (e.g., a layer composed of SiN or SiC), whereby the friction coefficient with the protective layer of the recording material increases and the sticking and noise problems actually worsen. Several attempts have been made to improve the current situation by increasing the amount of lubricant incorporated in the protective layer. However, an increased amount of lubricant leads to another problem in that after the recording, the molten lubricant crystallizes on the surface of the protective layer to produce a whitish surface, making the traces of fingerprints or the like conspicuous. Hence, an improved heat-sensitive recording material and heat-sensitive recording method are needed.

### SUMMARY OF THE INVENTION

The present invention has been made in light of the conventional problems and aims to achieve the following. Specifically, it is an object of the invention to provide a heat-sensitive recording material that exhibits excellent head matching. Another object of the invention is to provide a heat-sensitive recording material that can exhibit sufficient head matching with a thermal head that has a surface layer principally composed of carbon to exert excellent resistance to abrasion. Yet another object of the invention is to provide a heat-sensitive recording material that can form high-quality images without inducing any surface-whitening phenomena after the recording.

A first aspect of the present invention is a heat-sensitive recording material that contains, as a heat-fuisible substance, a derivative of a higher fatty acid in which one or more hydrogen atoms in an alkyl group are replaced with hydroxyl groups.

A second aspect of the invention is a heat-sensitive recording method in which recording is carried out by applying thermal energy to a heat-sensitive recording material via a thermal head having an uppermost layer whose carbon content is 90% or higher.

### DESCRIPTION OF THE INVENTION

An embodiment of the heat-sensitive recording material of the present invention will be described in detail below.

The heat-sensitive recording material of the invention is configured so that a heat-sensitive recording layer and a protective layer are disposed on a substrate with additional layers provided as necessary.

Protective Layer

The aforementioned protective layer can be provided on the heat-sensitive recording layer, or, in the case of an intermediate layer being provided, on such an intermediate layer.

The protective layer is formed by employing a coating liquid for use as the protective layer, with such a coating liquid preferably including a heat-fusible substance in order to improve the matching with the head. The coating liquid for the protective layer may further include one or more other components.

(Heat-Fusible Substance)

The heat-fusible substance of the present invention is featured by a derivative of a higher fatty acid in which one or more hydrogen atoms in an alkyl group are replaced with hydroxyl groups. In the above-mentioned higher fatty acid, there can be employed, for example, 2-hydroxylauric acid, 2, 10-dihydroxytridecanoic acid, 2-hydroxymyristic acid, 3, 11-dihydroxymyristic acid, 11-hydroxypentadecanoic acid, 2, 15-dihydroxypentadecanoic acid, 2-hydroxypalmitic acid, 11-hydroxypaimitic acid, 15, 16-dihydroxypalmitic acid, 2, 15, 16-trihydroxypalmitic acid, 8, 9, 16-trihydroxypalimitc acid, 9, 10, 16-trihydroxypalmitic acid, 9, 10-dihydroxystearic acid or 12-hydroxystearic acid, among which the preferred is 12-hydroxystearic acid.

Examples of derivatives of 12-hydroxystearic acid include 12-hydroxystearic acid, a metal salt of 12-hydroxystearic acid, an amide of 12-hydroxystearic acid and an ester of 12-hydroxystearic acid.

Specific examples of the metal salts of 12-hydroxystearic acid include lithium 12-hydroxystearate, calcium 12-hydroxystearate and zinc 12-hydroxystearate, among which the preferred examples are calcium 12-hydroxystearate and zinc 12-hydroxystearate. Also, the specific examples of the amides of 12-hydroxystearic acid include 12-hydroxystearic acid amide, N-(2-hydroxyethyl)-12-hydroxystearic acid amide, N, N′-ethylenebis-12-hydroxystearic acid amide, N, N′-hexamethylenebis-12-hydroxystearic acid amide and N, N′-xylilenebis-12-hydroxystearic acid amide, among which the preferred examples are 12-hydroxystearic acid amide, N-(2-hydroxyethyl)-12-hydroxystearic acid amide and N, N′-ethylenebis-12-hydroxystearic acid amide.

A 12-hydroxystearic acid ester is an esterified compound of 12-hydroxystearic acid and a monohydric or polyhydric alcohol. An example of such an esterified compound can be obtained by an esterifying reaction of 12-hydroxystearic acid and a monohydric or polyhydric alcohol using known methods in the art. Examples of monohydric or polyhydric alcohol employable in such a reaction include methanol, butanol, propylene glycol, ethylene glycol, glycerin, trinethylol propane, octanol and 2-ethylhexanol, among which the preferred are glycerin and ethylene glycol.

Examples of esterified compounds of 12-hydroxystearic acid and glycerin include glycerin mono-12-hydroxystearate, glycerin di-12-hydroxystearate and glycerin tri- 12-hydroxystearate, among which the preferred example is glycerin tri-12-hydroxystearate. Glycerin tri-12-hydroxystearate can also be obtained by hydrogenation of castor oil, principally composed of glycerin tricinoleate, in the presence of a reducing nickel catalyst, at a reaction temperature of 150 to 160° C. and under a reaction pressure of 10 to 20 kg/cm².

The heat-fusible substance preferably has a melting point within a range of 400 to 160° C., and more preferably from 50° to 150° C.

The aforementioned heat-fusible substance is employed either in the form of 1) an aqueous dispersion prepared by dispersion with a known dispersing equipment such as a homogenizer, a dissolver or a sand mill in the presence of a water-soluble polymer such as polyvinyl alcohol or a dispersant such as one of various available surfactants, or 2) an emulsion prepared by dissolution in a solvent followed by emulsification by dispersion with a known emulsifying equipment, such as a homogenizer, a dissolver or a colloid mill in the presence of a water-soluble polymer or a dispersant such as one of various available surfactants.

The average particle size of such a dispersion or an emulsion is preferably within a range of about 0.1 to 5.0 μm, more preferably from 0.1 to 2.0 μm. The above-mentioned average particle size indicates a 50% averaged particle size measured at a transmittance of 75±1% using a laser diffraction particle size distribution measuring apparatus LA700, which is manufactured by Horiba Seisakusho Co. of Japan.

The proportion of the aforementioned heat-fusible substance in the total dry coating amount of the protective layer is within a range of 0.5 to 10% by mass, and, a proportion within such a range provides a sufficient head matching without causing drawbacks such as a head smearing or a surface sticking. A more preferred range is 1 to 5% by mass. In the protective layer of the heat-sensitive recording material of the present invention, there may also be used in combination with the heat-fusible substance a known lubricant, for example: a paraffin wax, a higher fatty acid, a higher fatty acid salt, a higher fatty acid amide, a silicone compound or a fluorine-containing compound, and/or another heat-fusible substance other than the aforementioned heat-fusible substance.

Examples of heat-fuisible substances other than the aforementioned heat-fusible substance include montan wax, carnauba wax, microcrystalline wax, polyethylene wax, polyoxyethylene carboxylic acid ester and polyoxyethylene phosphoric acid ester.

(Pigment)

The protective layer of the heat-sensitive recording material of the present invention may further include a pigment in addition to the aforementioned heat-fusible substance. A pigment is usually employed for the purpose of producing the recording with a thermal head in an advantageous manner, namely for suppressing the generation of sticking or unwanted noises, and it is preferred to employ an organic pigment and/or an inorganic pigment.

The pigment employable in the protective layer preferably has an average particle size preferably ranging from 0.10 to 5.0 μm, and more preferably ranging from 0.20 to 0.50 μm so as to prevent generation of sticking or noises between the thermal head and the heat-sensitive recording material at the recording with the thermal head. The “average particle size” is preferably a 50% volume-averaged particle size measured by a laser diffraction method, wherein the average particle of pigment particles measured with a laser diffraction particle size distribution measuring apparatus LA700 corresponds to 50% in the volume of the pigment.

A 50% volume-averaged particle size within the range of 0.10 to 5.0 μm significantly reduces the abrasion of the thermal head and avoids the fused adhesion between the thermal head and a binder in the protective layer, thereby effectively preventing so-called sticking phenomenon, which occurs when the thermal head and the protective layer of the heat-sensitive recording material mutually adhere at the recording operation.

The pigment contained in the protective layer is not particularly limited to a specified pigment but can be a known organic or inorganic pigment, with the preferred pigment being an inorganic pigment such as calcium carbonate, titanium oxide, kaolin, aluminum hydroxide, amorphous silica or zinc oxide, or being an organic pigment such as urea-formalin resin or epoxy resin. Among these, the more preferred is kaolin, aluminum hydroxide or amorphous silica. These pigments may be used singly or in combination of two or more thereof.

Also, these pigments may be coated at their surface with at least one compound selected from the group consisting of a higher fatty acid, a higher fatty acid metal salt and a higher alcohol.

Examples of such a higher fatty acid include stearic acid, palmitic acid, myristic acid and lauric acid.

Such a pigment is preferably used after dispersion to the preferred average particle size by a known dispersing machine such as a dissolver, a sand mill or a ball mill, in the presence of an auxiliary dispersant such as sodium hexamethaphosphorate, partially or completely saponified modified polyvinyl alcohol, a polyacrylic acid copolymer or various surfactants, preferably in the presence of partially or completely saponified modified polyvinyl alcohol or ammonium salt of a polyacyrlic acid copolymer. Specifically, the pigment is preferably used after dispersion until the 50% volume-averaged particle size reaches a range of 0.10 to 5.00 μm.

(Binder)

In order to attain a satisfactory transparency in the protective layer, the aforementioned binder is preferably polyvinyl alcohol, carboxy-modified polyvinyl alcohol or silica-modified polyvinyl alcohol.

(Other Components)

The protective layer may include a known film hardener.

Also, in order to form the protective layer uniformly on the heat-sensitive recording layer or the intermediate layer, a surfactant is preferably added to the coating liquid for forming the protective layer. Such a surfactant can be an alkali metal salt of sulfosuccinic acid or a fluorine-containing surfactant, and specific examples include sodium salt, potassium salt or ammonium salt of di-(2-ethylhexyl)sulfosuccinic acid and di-(n-hexyl)sulfosuccinic acid.

Furthermore, for the purpose of preventing the charging of the heat-sensitive recording material, a surfactant, fine particles of a metal oxide, an inorganic electrolyte or a polymer electrolyte may be added to the protective layer.

Additionally, the protective layer may have a single-layered structure or it may have a laminated structure of two or more layers. The protective layer preferably has a dry coating amount of 0.2 to 7 g/m², and more preferably of 1 to 4 g/m².

Heat-sensitive Recording Layer

The heat-sensitive recording layer includes at least one color developing component, and one or more other components as necessary.

(Color Developing Component)

The heat-sensitive recording layer can be of any composition as long as it has an excellent transparency in an unprocessed state and as long-as it exhibits color development under heating.

Such a heat-sensitive recording layer can be a two-component heat-sensitive recording layer which word include a substantially colorless color developing component A and a substantially colorless color developing component B capable of developing a color by reacting with the color developing component A, with such color developing component A or color developing component B preferably contained in microcapsules. The combination of the two components constituting the above described two-component heat-sensitive recording layer can be any of following (a) to (m):

(a) a combination of an electron-donating dye precursor and an electron-accepting compound;

(b) a combination of a photodegradable diazo compound and a coupler;

(c) a combination of an organometallic salt such as silver behenate or silver stearate, and a reducing agent such as protocatechuic acid, spiroindane or hydroquinone;

(d) a combination of a long-chain aliphatic salt such as ferric stearate or ferric myristate, and a phenol such as gallic acid or ammonium salicylate;

(e) a combination of a heavy metal salt of an organic acid, such as a nickel, cobalt, lead, copper, iron, mercury or a silver salt of acetic acid, stearic acid or palmitic acid, and an alkali earth metal sulfide such as calcium sulfide, strontium sulfide or potassium sulfide, or a combination of the aforementioned heavy metal salt of the organic acid and an organic chelating agent such as s-diphenylcarbazide or diphenylcarbazone;

(f) a combination of a (heavy) metal sulfate salt such as silver sulfide, lead sulfide, mercury sulfide or sodium sulfide, and a sulfur compound such as Na-tetrathionate, sodium thiosulfate or thiourea;

(g) a combination of an aliphatic ferric salt such as ferric stearate, and an aromatic polyhydroxy compound such as 3,.4-dihydroxytetraphenyl-methane;

(h) a combination of an organic precious metal salt such as silver oxalate or mercury oxalate, and an organic polyhydroxy compound such as polyhydroxy alcohol, glycerin or glycol;

(i) a combination of an aliphatic ferric salt such as ferric pelargonate or ferric laurate, and a derivative of thiocetylcarbamide or isothiocetylcarbamide;

j) a combination of an organic acid lead salt such as lead caproate, lead pelargonate or lead behenate, and a thiourea derivative such as ethylene thiourea or N-dodecyl thiourea;

(k) a combination of a heavy metal salt of a higher fatty acid such as ferric stearate or copper stearate, and a zinc dialkyl-dithiocarbamate;

(l) a combination capable of forming an oxazine dye such as a combination of resorcin and a nitroso compound; and

(m) a combination of a formazane compound and a reducing agent and/or a metal salt.

Among these, there is preferably employed, in the heat-sensitive recording material of the invention, (a) a combination of an electron-donating dye precursor and an electron-accepting compound, (b) a combination of a photodegradable diazo compound and a coupler, or (c) a combination of an organometallic salt and a reducing agent, with the more preferable combinations being (a) or (b).

Also, the heat-sensitive recording material of the present invention can provide an image excellent in transparency by so constructing the heat-sensitive recording layer as to reduce the haze value, calculated by the equation: (diffuse transmittance)/(total optical transmittance)×100 (%). Such haze amount is an index indicating the transparency of the material, and is, in general, calculated from a total light transmission, a diffuse light transmission and a parallel light transmission, utilizing a haze meter.

In the present invention, a reduction in the haze value can be achieved, for example, by a method of selecting the 50% volume-averaged particle size of both color developing components A and B, contained in the heat-sensitive recording layer at 1.0 μm or less, preferably 0.6 μm or less, and selecting the content of the binder within a range of 30 to 60% by mass with respect to the total solid of the heat-sensitive recording layer or also for example, by a method of microencapsulating either of the color developing components A or B and using the non-microencapsulated component in a state constituting a substantially continuous layer after coating and drying, such as an emulsion state.

It is also effective to use a method of selecting the refractive indexes of the components used in the heat-sensitive recording layer as close as possible to a certain value.

In the following, a detailed explanation will be given on the various aforementioned combinations (a, b, c) of the composition advantageously employed in the heat-sensitive recording layer.

First, the combination (a) of an electron-donating dye precursor and an electron-accepting compound is explained.

The electron-donating dye precursor advantageously employed in the present invention is not particularly limited as long as it is substantially colorless, but it has a property of developing a color by donating an electron or accepting a proton for example of an acid, and it is preferably a colorless compound, having a partial skeleton of a lactone, a lactam, a sultone, a spiropyran, an ester or an amide and causing a ring opening or a cleavage of such partial skeleton upon contact with the electron-accepting compound.

Examples of the electron-donating dye precursor include triphenylmethane phthalide-based compounds, fluoran-based compounds, phenothiazine-based compounds, indolyl phthalide-based compounds, leuco auramine-based compounds, rhodamine lactam-based compounds, triphenylmethane-based compounds, triazene-based compounds, spiropyran-based compounds, fluorene-based compounds, pyridine-based compounds and pyrazine compounds.

Specific examples of the phthalides include compounds described in U.S. Re-issued Pat. No. 23,024, and U.S. Pat. Nos. 3,491,111, 3,491,112, 3,491,116 and 3,509,174.

Specific examples of the fluorans include compounds described in U.S. Pat. Nos. 3,624,107, 3,627,787, 3,641,011, 3,462,828, 3,681,390, 3,920,510 and 3,959,571.

Specific examples of the spiropyrans include compounds described in U.S. Pat. No. 3,971,808.

Specific examples of the pyridines and pyrazines include compounds described in U.S. Pat. Nos. 3,775,424, 3,853,869 and 4,246,318.

Specific examples of the fluorenes include compounds described in Japanese Patent Application No. 61-240989.

Among these, particularly preferred are 2-arylamino-3-[H, halogen, alkyl or alkoxy-6-substituted aminofluorans.]

Specific examples include: 2-anilino-3-methyl-6-diethylaminofluoran, 2-anilino-3-methyl-6-N-cyclohexyl-N-methylaminofluoran, 2-p-chloroanilino-3-methyl-6-dibutylaminofluoran, 2-anilino-3-methyl-6-dioctylaminofluoran, 2-anilino-3-chloro-6-diethylaminofluoran, 2-anilino-3-methyl-6-N-ethyl-N-isoamylaminofluoran, 2-anilino-3-methyl-6-N-ethyl-N-dodecylaminoflouran, 2-anilino-3-methoxy-6-dibutylaminofluoran, 2-o-chloraanilino-6-dibutylaminofluoran, 2-p-chloroanilino-3-ethyl-6-N-ethyl-N-isoamylaminofluoran, 2-o-chloroanilino-6-p-butylanilinofluoran, 2-anilino-3-pentadecyl-6-diethylaminoiluoran, 2-anilino-3-ethyl-6-dibutylaminofluoran, 2-o-toluidino-3-methyl-6-diisopropylaminofluoran, 2-anilino-3-methyl-6-N-isobutyl-N-ethylaminofluoran, 2-anilino-3-methyl-6-N-ethyl-N-tetrahydrofurfurylaminofluoran, 2-anilino-3-chloro-6-N-ethyl-N-isoamylaminofluoran, 2-anilino-3-methyl-6-N-methyl-N-γ-ethoxypropylaminofluoran, 2-anilino-3-methyl-6-N-ethyl-N-γ-ethoxypropylaminofluoran, and 2-anilino-3-methyl-6-N-ethyl-N-γ-propoxypropyl-aminofluoran.

The electron-accepting compound to react with the electron-donating dye precursor can be an acidic substance such as a phenol compound, an organic acid or a salt thereof, or an oxybenzoic acid ester, and examples of the compound include compounds described in, for example, JP-A No. 61-291183.

Specific examples include: bisphenols such as 2, 2-bis(4′-hydroxyphenyl) propane (generally called bisphenol A), 2, 2-bis(4′-hydroxyphenyl) pentane, 2, 2-bis(4′-hydroxy-3 ′, 5′-dichlorophenyl) propane, 1, 1-bis(4′-hydroxyphenyl) cyclohexane, 2, 2-bis(4′-hydroxyphenyl) hexane, 1, 1-bis(4′-hydroxyphenyl) propane, 1, 1-bis(4′-hydroxyphenyl) butane, 1, 1-bis(4′-hydroxyphenyl) pentane, 1, 1-bis(4′-hydroxyphenyl) hexane, 1, 1-bis(4′-hydroxyphenyl) heptane, 1, 1-bis(4′-hydroxyphenyl) octane, 1, 1-bis(4′-hydroxyphenyl)-2-methyl-pentane, 1, 1-bis(4′-hydroxyphenyl)-2-ethyl-hexane, 1, 1-bis(4′-hydroxyphenyl)dodecane, 1, 4-bis(p-hydroxyphenylcumyl)benzene, 1, 3-bis(p-hydroxyphenylcumyl) benzene, bis(p-hydroxyphenyl)sulfone, bis(3-allyl-4-hydroxyphenyl)sulfone, bis(p-hydroxyphenyl)acetic acid benzyl ester, triethyleneglycol-bis[3-(3-t-butyl-5-methyl-4-hydroxyphenyl)propionte], n-octadecyl-3-(3, 5-di-t-butyl-4-hydroxyphenyl)propionate, 2, 2′-methylenebis-(4-ethyl-6-t-butylphenol), 4, 4′-thiobis-(3-methyl-6-t-butylphenol), or 2, 2′-methylenebis-(4-methyl-6-t-butylphenol);

salicylic acid derivatives such as 3, 5-di-(α-methylbenzyl)salicylic acid, 3, 5-di-(t-butyl)salicylic acid, 3-α-α-dimethylbenzylsalicylic acid, or 4-(β-p-methoxyphenoxyethoxy)salicylic acid, and polyvalent metal (particularly of zinc or aluminum) salts thereof;

oxybenzoic acid esters such as benzyl p-hydroxybenzoate, p-hydroxybenzoate-2-ethylhexyl or β-resorcylic acid-2-phenoxyethane; and phenols such as p-phenylphenol, 3, 5-diphenylphenol, cumylphenol, 4-hydroxy-4′-isopropoxy-diphenylsulfone, or 4-hydroxy-4′-phenoxy-diphenylsulfone.

Among the above-listed compounds, in view of obtaining satisfactory color developing property, particularly preferred are bisphenols and zinc salts of salicylic acid derivatives.

The electron-accepting compounds listed above may be used singly or in combination of two or more thereof.

Next, the combination (b) of a photodegradable diazo compound and a coupler is explained.

The photodegradable diazo compound is a diazo compound having a photodegradable property and which is capable of causing a coupling reaction with a coupler, which is a coupling component to be explained later, thereby developing a color of a desired color hue, but, being decomposed by the light of a specified wavelength region prior to such a reaction thereby no longer showing the color developing ability even in the presence of the coupling component.

The color hue in this color developing system is determined by a diazo dye generated by the reaction between the diazo compound and the coupler. Therefore, the developed color hue can be easily altered by changing the chemical structure of the diazo compound or the coupler, and can be arbitrarily selected depending on the combination thereof

The photodegradable diazo compound preferably employed in the invention can be an aromatic diazo compound, and specific examples thereof include aromatic diazonium salts, diazosulfonate compounds and diazoamino compounds.

For use in the present invention, the aromatic diazonium salt preferably shows an excellent photofixation, little colored stain formation after the fixation and a stable developed color; and is a compound represented by the following general formula, with such an example not being restrictive.

Ar—N₂⁺X⁻

wherein Ar represents a substituted or non-substituted aromatic hydrocarbon cyclic group; N₂⁺represents a diazonium group; and X⁻ stands for an acid anion.

The diazosulfonate compound is recently known to be found in many forms, and can be obtained by processing a corresponding diazonium salt with a sulfite salt, and can furthermore be advantageously employed in the heat-sensitive recording material of the present invention.

The diazoamino compound can be obtained by coupling the diazo group with dicyandiamide, sarcosine, methyltaurine, N-ethylanthranic acid-5-sulfonic acid, monoethanolamine, diethanolamine or guanidine, and the compound can be advantageously employed in the heat-sensitive recording material of the present invention.

These diazo compounds are described in detail in, for example, JP-A No. 2-136286.

On the other hand, the coupler for causing a coupling reaction with the aforementioned diazo compound can be, for example, 2-hydroxy-3-naphthoeic acid anilide, resorcin, or those described in JP-A No. 62-146678.

In case of employing the combination of a diazo compound and a coupler in the heat-sensitive recording layer, a basic substance may be added as a sensitizer, in consideration of a fact that such coupling reactions can be further accelerated under a basic atmosphere.

Such a basic substance can be a water-insoluble, a low-soluble basic substance or a substance generating an alkali under heating, and examples of the basic substance include nitrogen-containing compounds such as inorganic or organic ammonium salts, organic amines, amides, urea or thiourea or derivatives thereof, thiazoles, pyrroles, pyrimidines, piperazines, guanidines, indoles, imidazoles, imidazolines, triazoles, morphorines, piperidines, amidines, folimuazines and pyridines.

Specific examples thereof include those described in JP-A No. 61-291183.

Next, the combination (c) of an organometallic salt and a reducing agent is explained.

Specific examples of the organic metal salt include silver salt of a long-chain aliphatic carboxylic acid such as silver laurate, silver myristate, silver palmitate, silver stearate, silver arachate or silver behenate; silver salt of an organic compound having an imino group such as benzotriazole silver salt, benzimidazole silver salt, carbazole silver salt or phthalazinone silver salt; silver salt of a sulfur-containing compound such as s-alkylthioglycolate; silver salt of an aromatic carboxylic acid such as silver benzoate or silver phthalate; silver salt of a sulfonic acid such as silver ethanesulfonate; silver salt of a sulfinic acid such as silver o-toluenesulfimate; silver salt of a phosphoric acid such as silver phenylphosphorate; silver barbiturate, silver saccharate, silver salt of salicylaldoxime and an arbitrary mixture thereof.

Among these, a silver salt of long-chain aliphatic carboxylic acid is preferable, and silver behenate is more preferable. Also behenic acid may be used in combination with silver behenate.

The reducing agent can be suitably used, based on the description of JP-A No. 53-1020, from p.227, lower left column, line 14 to p.229, upper right column, line 11. Among those, particularly preferred are mono-, bis-, tris- or tetrakis-phenols, mono- or bis-naphtols, di- or poly-hydroxynaphthalenes, di- or poly-hydroxybenzenes, hydroxymonoethers, ascorbic acids, 3-pyrazolidones, pyrazolines, pyrazolones, reducing sugars, phenylenediamines, hydroxylamines, reductones, hydroxamic acids, hydrazides, amidoximes, and N-hydroxyureas.

Among these, particularly preferred are aromatic organic reducing agents such as polyphenols, sulfonamide phenols or naphthols.

In order to secure a sufficient transparency in the heat-sensitive recording material, it is preferred to use, in the heat-sensitive recording layer, the combination (a) of the electron-donating dye precursor and the electron-accepting compound, or the combination (b) of the photodegradable diazo compound and the coupler. Also in the invention, it is preferable to encapsulate either of the color developing component A or the color developing component B, and more preferable to encapsulate the electron-donating dye precursor or the photodegradable diazo compound.

(Microcapsules)

In the following a detailed explanation will be given on a method of producing microcapsules.

For producing microcapsules, there are known for example an interfacial polymerization method, an internal polymerization method and an external polymerization method, any of which may be employed.

In the heat-sensitive recording material of the invention, as explained in the foregoing, it is preferable to encapsulate the electron-donating dye precursor or the photodegradable diazo compound, and it is particularly preferable to employ an interfacial polymerization method by mixing an oil phase, which is prepared by dissolving or dispersing the electron-donating dye precursor or the photodegradable diazo compound constituting the core of the capsules in a hydrophobic organic solvent, in an aqueous phase in which a water-soluble polymer is dissolved, and, after emulsification by dispersion for example with a homogenizer, heating the emulsion to cause a polymer forming reaction at the interface of the oil drops thereby forming a microcapsule wall of a polymer substance.

A reactant for forming the aforementioned polymer substance is added to the interior of the oil drops and/or the exterior of the oil drops. Specific examples of the polymer substance include polyurethane, polyurea, polyamide, polyester, polycarbonate, urea-formaldehyde resin, melamine resin, polystyrene, styrene/methacrylate copolymer, and styrene/acrylate copolymer. Among these, the preferred are polyurethane, polyurea, polyamide, polyester or polycarbonate, with particularly preferred being polyurethane or polyurea.

For example, in case of employing polyurea as the capsule wall material, the microcapsule wall can be easily formed by reacting a polyisocyanate such as diisocyanate, triisocyanate, tetraisocyanate or polyisocyanate prepolymer with a polyamine such as diamine, triamine or tetramine, a prepolymer having two or more amino groups, piperazine or a derivative thereof, or a polyol through the interfacial polymerization method in the aforementioned aqueous phase.

Also, a composite wall composed of, for example, polyurea and polyamide or polyurethane and polyamide can be prepared, for example, by mixing a polyisocyanate and a second substance capable of reacting therewith (e.g., acid chloride, polyamine or polyol) to form a capsule wall, in an aqueous solution of a water-soluble polymer (aqueous phase) or in an oil medium (oil phase) to be encapsulated, and, after emulsification by dispersion, by heating. The method of producing a composite wall composed of polyurea and polyamide is described in detail in JP-A No. 58-66948.

The aforementioned polyisocyanate compound is preferably a tri- or higher-functional isocyanate compound, but a bi-functional isocyanate compound may be used in combination.

Specific examples include xylene diisocyanate and hydrogenated products thereof, hexamethylene diisocyanate, tolylene diisocyanate and hydrogenated products thereof, a product principally made of a diisocyanate such as isophoronediisocyanate in the form of a dimer or a trimer (biuret or isocyanulate), a polyfunctional adduct of a polyol such as trimethylol propane with a bifunctional isocyanate such as xylilene diisocyanate, a compound formed by introducing, into an adduct of a polyol such as trimethylol propane and a bifunctional isocyanate such as xylilene diisocyanate, a high molecular compound such as a polyether having an active hydrogen such as polyethylene oxide, and a formalin condensate of benzene isocyanate.

Preferable compounds are described in JP-A Nos. 62-212190, 4-26189 and 5-317694 and Japanese Patent Application No. 8-268721.

The polyisocyanate described above is preferably added so that the microcapsules have an averaged particle size of 0.3 to 12 μm and a capsule wall thickness of 0.01 to 0.3 μm. The diameter of the dispersed particles is generally in a range of about 0.2 to 10 μm.

Specific examples of polyol and/or polyamine, to be added to the aqueous phase and/or the oil phase for reacting with polyisocyanate as one of the constituents of the microcapsule wall, include propylene glycol, glycerin, trimethylol propane, triethanolamine, sorbitol, hexamethylenediamine, ethylenediamine, diethylenetriamine, triethylenetetramine, and tetraethylenepentamine. In case of adding polyol, there is formed a polyurethane wall. In the aforementioned reaction, it is preferable to maintain an elevated reaction temperature or to add a suitable polymerization catalyst, in order to increase the reaction rate.

Polyisocyanate, polyol, reaction catalyst, and polyamine constituting a part of the wall are detailed in a reference (Polyurethane Handbook, Nikkan Kogyo Shimbun-sha, edited by Keiji Iwata (1987)).

In the microcapsule wall, there may be incorporated if necessary a metal-containing dye, a charge control agent such as nigrosine, or other arbitrary additives. Such additives may be included in the capsule wall upon formation thereof or at an arbitrary point. Also in order to adjust the chargeability of the capsule wall, there may be graft-polymerized, a monomer such as a vinyl monomer as necessary.

Further, in order to render the microcapsule wall to have a sufficient material permeability and a sufficient color developing property even in a lower temperature, preferably used is a plasticizer that is suitable for the polymer to be used as the wall material. Such a plasticizer has a melting point preferably equal to or higher than 50° C., and more preferably not exceeding 120° C. Among such plasticizers, there can be suitably selected one that is in a solid state at the normal temperature.

For example, in case the wall material is made of polyurea or polyurethane, there can be advantageously employed a hydroxy compound, a carbamic acid ester, an aromatic alkoxy compound, an organic sulfonamide compound, an aliphatic amide or an arylamide.

In the preparation of the aforementioned oil phase, the hydrophobic organic solvent, that is used for dissolving the electron-donating dye precursor or the photodegradable diazo compound when forming the core of the microcapsules, is preferably an organic solvent having a boiling point within a range of 100° to 300° C.

Specific examples include, in addition to esters, dimethylnaphthalene, diethylnaphthalene, diisopropylnaphthalene, dimethylbiphenyl, diisopropylbiophenyl, diisobutylbiphenyl, 1-methyl-1-dimehylphenyl-2-phenyl methane, 1-ethyl-1-dimnethylphenyl-1-phenyl methane, 1-propyl-1-dimethylphenyl-1-phenylmethane, triallylmethanes (e.g., tritoluylmethane or toluyldiphenylmethane), terphenyl compounds (e.g., terphenyl), alkyl compounds, alkylated diphenylether (e.g., propyldiphenylether), hydrogenated terphenyls (e.g., hexahydroterphenyl), and diphenylether. Among these, esters are particularly preferred in consideration of stability of the emulsified dispersion.

Examples of the esters include phosphoric acid esters such as triphenyl phosphate, tricresyl phosphate, butyl phosphate, octyl phosphate or cresylphenyl phosphate; phthalic acid esters such as dibutyl phthalate, 2-ethylhexyl phthalate, ethyl phthalate, octyl phthalate or butylbenzyl phthalate; dioctyl tetrahydrophthalate; benzoic acid esters such as ethyl benzoate, propyl benzoate, butyl benzoate, isopentyl benzoate or benzyl benzoate; abietic acid esters such as ethyl abietate or benzyl abietate; dioctyl azipate; isodecyl succinate; dioctyl azelate; oxalic acid esters such as dibutyl oxalate or dipentyl oxalate; diethyl malonate; maleic acid esters such as dimethyl maleate, diethyl maleate or dibutyl maleate; tributyl citrate; sorbic acid esters such as methyl sorbate, ethyl sorbate or butyl sorbate; sebacic acid esters such as dibutyl sebacate or dioctyl sebacate; ethylene glycol esters such as formic acid monoester or diester, butyric acid monoester or diester, lauric acid monoester or diester, palmitic acid monoester or diester, stearic acid monoester or diester, or oleic acid monoester or diester; triacetin; diethyl carbonate; diphenyl carbonate; ethylene carbonate; propylene carbonate; and boric acid esters such as tributyl borate or tripentyl borate.

Among these, tricresyl phosphate used singly or in a mixture is particularly preferable because the stability of the emulsion can be optimized. A combined use of the above-mentioned oils or with another oil is also possible.

In case the electron-donating dye precursor or the photodegradable diazo compound to be encapsulated has a lower solubility in the aforementioned hydrophobic organic solvent, a low-boiling solvent with a high solubility may be used in combination as an auxiliary solvent. Preferred examples of such a low-boiling solvent include ethyl acetate, isopropyl acetate, butyl acetate and methylene chloride.

In case of utilizing the electron-donating dye precursor or the photodegradable diazo compound in the heat-sensitive recording layer of the heat-sensitive recording material, the content of the electron-donating dye precursor is preferably within a range of 0.1 to 5.0 g/m², more preferably 1.0 to 4.0 g/m².

Also, the content of the photodegradable diazo compound is preferably within a range of 0.02 to 5.0 g/m², more preferably 0.10 to 4.0 g/m² in consideration of a developed color density.

The content of the electron-donating dye precursor within a range of 0.1 to 5.0 g/m² provides a sufficient developed color density and maintains the transparency of the heat-sensitive recording layer.

On the other hand, the aqueous phase to be employed is made of an aqueous solution in which a water-soluble polymer is dissolved as a protective colloid, and after the charging of the oil phase therein, emulsification by dispersion is conducted for example using a homogenizer, and the above-mentioned water-soluble polymer functions to make a dispersion medium uniform and stabilizes the dispersed and emulsified aqueous solution. For the purpose of achieving further uniform dispersion and further stability, a surfactant may be added to at least either of the oil phase or the aqueous phase. The surfactant can be a conventionally known surfactant for emulsification. The amount of the surfactant is preferably from 0.1 to 5%, and more preferably from 0.5 to 2% with respect to the mass of the oil phase.

The surfactant to be included in the aqueous phase can be suitably selected from anionic or nonionic surfactants so as not to effect precipitation or coagulation by an interaction with the protective colloid.

Preferred examples of the surfactant include sodium alkylbenzenesulfonate, sodium alkylsulfate, dioctyl sulfosuccinate sodium salt, and polyalkylene glycol (e.g., polyoxyethylene nonylphenyl ether).

The emulsification can be readily conducted by emulsifying the oil phase including the aforementioned components with the aqueous phase including the protective colloid and the surfactant, using an apparatus ordinarily utilized for fine particle emulsification through high-speed agitation or ultrasonic dispersion, for example, a known emulsifying apparatus such as a homogenizer, a manton golly, an ultrasonic dispersing machine, a dissolver or Kady mill. After the emulsification, it is preferable to heat the emulsion at 30° to 70° C. in order to accelerate the capsule wall forming reaction. Also in the course of the reaction, in order to prevent mutual coagulation of the capsules, it is preferable to add water for reducing the tendency of mutual collision of the capsules or to provide sufficient agitation.

Further, it is preferable to add another dispersion for preventing coagulation in the course of the reaction. Generation of carbon dioxide gas is observed with the progress of the polymerization reaction, and the end of such gas generation can be regarded as an approximate end point of the capsule wall forming reaction. Normally, desired microcapsules can be obtained after a reaction proceeded for several hours.

(Emulsified Dispersion)

In case of encapsulating the electron-donating dye precursor or the photodegradable diazo compound as the core material, the electron-accepting compound or the coupler may be dispersed in a solid phase together with, for example, the water-soluble polymer, the organic base and other color developing auxiliary substance, for example utilizing a sand mill. It is more preferable to use an emulsified dispersion obtained by dissolving these substances in advance in a high-boiling organic solvent which is low-soluble or insoluble in water, then mixing the solution with an aqueous polymer solution (aqueous phase) including the surfactant and/or the water-soluble polymer as the protective colloid, and emulsifying the mixture using, for example, the homogenizer. In such a case, a low-boiling solvent may be employed as an auxiliary solvent if necessary.

Also, the coupler and the organic base may be subjected to emulsification by dispersing them either separately, or after mixing and dissolving them in the high-boiling organic solvent. A preferred particle size of the emulsified dispersion is 1 μm or less.

The high-boiling organic solvent to be employed in this operation can be suitably selected from high-boiling oils described in, for example, JP-A No. 2-141279.

Among these, esters are preferred in consideration of stability emulsification of the emulsified dispersion liquid, with tricresyl phosphate being particularly preferable. A combined use of the above-mentioned oils or use with another oil is also possible.

The water-soluble polymer included as the protective colloid can be suitably selected from conventionally known anionic polymers, nonionic polymers and amphoteric polymers. Preferred is a water-soluble polymer having a solubility in water of 5% or higher at a temperature to be used for the emulsification. Examples of the polymer include polyvinyl alcohol or a modified product thereof, polyacrylamride or a derivative thereof, ethylene/vinyl acetate copolymer, styrene/maleic anhydride copolymer, ethylene/maleic anhydride copolymer, isobutylene/maleic anhydride copolymer, polyvinylpyrrolidone, ethylene/acrylic acid copolymer, vinyl acetate/acrylic acid copolymer, a cellulose derivative such as carboxymethyl cellulose or methyl cellulose, casein, gelatin, a starch derivative, gum Arabic, and sodium alginate.

Among these, particularly preferred is polyvinyl alcohol, gelatin or a cellulose derivative.

Also, the mixing ratio of the oil phase to the aqueous phase (oil phase mass/aqueous phase mass) is preferably within a range of 0.02 to 0.6, and more preferably 0.1 to 0.4. The mixing ratio within the range of 0.02 to 0.6 provides an appropriate viscosity, which is sufficient for the production and for the stability of the coating liquid.

In case of employing the electron-accepting compound in the heat-sensitive recording material of the invention, use of the electron-accepting compound relative to 1 part of the electron-donating dye precursor is preferably within a range of 0.5 to 10 parts and more preferably 0.1 to 30 parts by mass.

In case of employing the coupler in the heat-sensitive recording material of the invention, use of the coupler relative to 1 part of the diazo compound, and preferably within a range of 0.1 to 30 parts by mass.

(Coating Liquid for Heat-sensitive Recording Layer)

The coating liquid for the heat-sensitive recording layer can be prepared, for example, by mixing a microcapsule liquid with an emulsified dispersion prepared as described supra. In such a case, the water-soluble polymer employed as the protective colloid in the preparation of the microcapsule liquid and the water-soluble polymer employed as the protective colloid in the preparation of the emulsified dispersion both function as the binder in the heat-sensitive recording layer. The coating liquid for the heat-sensitive recording layer may also be prepared by admixing a binder, separately with these protective colloids.

The above-mentioned binder to be added is generally water-soluble. Examples thereof include polyvinyl alcohol, hydroxyethyl cellulose, hydroxypropyl cellulose, epichlorohydrin-modified polyamide, ethylene/maleic anhydride copolymer, styrene/maleic anhydride copolymer, isobutylene/maleic anhydride copolymer, polyacrylic acid, polyacrylamide, methylol-modified polyacrylamide, starch derivatives, casein and gelatin.

It is also possible to add a water resistance agent, or an emulsion of a hydrophobic polymer such as a styrene-butadiene rubber latex or an acrylic resin emulsion, for the purpose of imparting water resistance to the binder.

When coating the coating liquid for the heat-sensitive recording layer on a substrate, there is employed a known coating apparatus for the coating liquid of an aqueous system or an organic solvent system. In such an operation, in order to coat the coating liquid for the heat-sensitive recording layer in a safe and uniform manner and to maintain the strength of the coated film, there may be employed, in the heat-sensitive recording material of the invention, methyl cellulose, carboxymethyl cellulose, hydroxyethyl cellulose, starches, gelatin, polyvinyl alcohol, carboxy-modified polyvinyl alcohol, polyacrylamide, polystyrene or a copolymer thereof, polyester or a copolymer thereof, polyethylene or a copolymer thereof, epoxy resin, acrylate resin or a copolymer thereof, methacrylate resin or a copolymer thereof, polyurethane resin, polyamide resin, or polyvinylbutyral resin.

(Other Components)

Hereinafter, other components employable in the heat-sensitive recording layer will be explained.

Other components are not particularly restricted but can be suitably selected according to the purpose, and examples thereof include a heat-fusible substance, an ultraviolet absorbent or an antioxidant known in the art. Also, in case of a heat-sensitive recording layer not having a protective layer, the heat-fusible substance of the invention (e.g., 12-hydroxystearic acid derivative) may be included therein.

Such a heat-fusible substance can be included in the heat-sensitive recording layer for the purpose of increasing a thermal response.

Examples of the heat-fusible substance include an aromatic ether, a thioether, an ester, an aliphatic amide and an ureido.

Examples of such substances are described in, for example, JP-A Nos. 58-57989, 58-87094, 61-58789, 62-109681, 62-132674, 63-151478, 63-235961, 2-184489 and 2-215585.

The ultraviolet absorbent may preferably be of benzophenone type, benzotriazole type, salicylic acid type, cyanoacrylate type or oxalic acid anilide type. Examples of these compounds are described in JP-A Nos. 47-10537, 58-111942, 58-212844, 59-19945, 59-46646, 59-10955 and 63-53544, JP-B Nos. 36-10466, 42-26187, 48-30492, 48-31255, 48-41572, 48-54965 and 50-10726, and U.S. Pat. Nos. 2,719,086, 3,707,375, 3,754,919 and 4,220,711.

The antioxidant may preferably be of hindered amine type, hindered phenol type, aniline type or quinoline type. Examples of these compounds are described in JP-A Nos. 59-155090, 60-107383, 60-107384, 61-137770, 61-139481 and 61-160287.

The coating amount of the other components described above is preferably about 0.05 to 2.0 g/m², and more preferably 0.1 to 1.0 g/m². Such components may be incorporated in the interior of the microcapsules or added to the exterior of the microcapsules.

In order to suppress an unevenness in density resulting from a slight difference in the thermal conduction of the thermal head and form high-quality images, the heat-sensitive recording layer preferably has a wide range of the energy width required for obtaining a saturated transmission density (D_{T-max}), namely a wide dynamic range. The heat-sensitive recording material of the present invention includes such a heat-sensitive recording layer which exhibits a transmission density D_{T} of 3.0 when applied with a thermal energy amount in a range of 90 to 150 mJ/m².

The heat-sensitive recording layer is preferably coated to provide a dry coating amount, after drying, within a range of 1 to 25 g/m² and a layer thickness of 1 to 25 μm. The heat-sensitive recording layer may be formed to have two or more layers. In such a case, the coating amount after drying of all the heat-sensitive recording layers is preferably from 1 to 25 g/m².

Substrate

As the substrate, polyester, in particular polyethylene terephthalate is advantageously used. When used for medical purposes, the transparent substrate may be colored with a blue dye (e.g., dyes described in the examples of JP-A No. 8-240877), or uncolored. The substrate is preferably subjected to undercoating with, for example, gelatin or water-soluble polyester. For the undercoat layer, there can be used, for example, those described in JP-A Nos. 51-11420, 51-123139 and 52-65422.

Other Layers

The heat-sensitive recording material of the invention may be provided, on the aforementioned substrate, with other layers such as an intermediate layer, an undercoat layer, an ultraviolet filter layer and/or a backing layer.

(Intermediate Layer)

The intermediate layer is preferably formed on the heat-sensitive recording layer.

The intermediate layer is provided for preventing mixing with other layers or preventing a harmful gas (e.g., oxygen) to affect the image storability. The binder to be employed is not particularly restricted, and there can be utilized polyvinyl alcohol, gelatin, polyvinylpyrrolidone or a cellulose derivative according to the system used. Among these materials, gelatin which exhibits good fluidity in the form of an aqueous solution (setting ability) at a high temperature but loses fluidity and is gelated at a low temperature (e.g., 35° C. or lower) can effectively prevent mutual mixing of two adjacent layers, in case of coating and drying coating liquids on the substrate for forming plural layers, not only in a method of coating and drying the plural layers successively but also in a method of coating and drying the plural layers at the same time by an extrusion die, thereby providing a satisfactory surface state on the obtained heat-sensitive recording material and achieving a heat-sensitive recording material capable of forming high-quality images. Thus, gelatin is suitable for a recording material for medical diagnosis which requires a clear image formation having detailed depiction. Further, the production efficiency is improved because the surface state is not deteriorated even when air-dried at a high speed. For such a gelatin, there can be employed unmodified (unprocessed) gelatin or modified (processed) gelatin. The modified gelatin can be, for example, lime-processed gelatin, acid-processed gelatin, phthalated gelatin, deionized gelatin, or enzyme-processed low molecular gelatin. Also various surfactants may be added for imparting coating property. Also for further increasing the gas barrier property, inorganic fine particles such as mica may be added, preferably in an amount of 2 to 20% by mass with respect to the binder, more preferably 5 to 10% by mass. The suitable binder concentration in the coating liquid for the intermediate layer is about 3 to 25% by mass, preferably 5 to 15% by mass. The dry coating amount of the intermediate layer is advantageously 0.5 to 6.0 g/m², and preferably 1.0 to 4.0 g/m².

(Undercoat Layer)

In the heat-sensitive recording material of the invention, for the purpose of preventing peeling of the heat-sensitive recording layer from the substrate, an undercoat layer may be provided on the substrate prior to coating the heat-sensitive recording layer which includes the microcapsules or a light-reflection preventing layer.

Into the undercoat layer, there can be incorporated an acrylic acid ester copolymer, polyvinylidene chloride, SBR or water-soluble polyester, and the layer thickness is preferably specified in a range of 0.05 to 0.5 μm.

In case of coating the heat-sensitive recording layer on the undercoat layer, there may arise a case that the undercoat layer swells because of water present in the coating liquid for the heat-sensitive recording layer to thereby deteriorate the image recorded on the heat-sensitive recording layer. Thus, the undercoat layer is preferably hardened with a film hardener, for example, dialdehydes such as glutaraldehyde or 2, 3-dihydroxy-1, 4-dioxane, or boric acid. The addition amount of the hardener can be suitably selected according to a desired level of hardening, within a range of 0.2 to 3.0% by mass depending on the mass of the undercoating material.

(Ultraviolet Filter Layer)

In the heat-sensitive recording material of the invention, an ultraviolet filter layer may be provided for preventing fading of images by light or a background fog. The ultraviolet filter layer is formed by uniformly dispersing an ultraviolet absorbent in a binder, and the uniformly dispersed ultraviolet absorbent effectively absorbs the ultraviolet light thereby preventing the discoloration of the background or the discoloration or fading of an image area caused by ultraviolet light. The method of preparing the ultraviolet filter layer and the compounds usable therein are described in JP-A No. 4-197778 in addition to the ultraviolet absorbents such as benzotriazole-type, benzophenone-type and hindered amine-types absorbents.

(Backing Layer)

The heat-sensitive recording material of the invention is preferably a one-sided thermosensitive material which has a heat-sensitive recording layer including the microcapsules on one side of the substrate and a backing layer on the other side. In the backing layer, a matting agent is preferably included for the purpose of improving the conveying property and preventing light reflection. The matting agent is preferably added such that gloss measured at an incident light angle of 20° is 50% or less, and more preferably 30% or less. Examples of the matting agent include not only fine particles such as a starch obtained from barley, wheat, corn, rice or beans, but also cellulose fibers, fine particles of a synthetic polymer such as polystyrene resin, epoxy resin, polyurethane resin, urea-formaldehyde resin, poly(meth)acrylate resin, polymethyl(meth)acrylate resin, a copolymer resin such as of vinyl chloride or vinyl acetate, or polyolefin, and inorganic fine particles such as calcium carbonate, titanium oxide, kaolin, smectite clay, aluminum hydroxide, silica or zinc oxide. The average particle size of the matting agent is preferably in a range of 0.5 to 20 μm, and more preferably 0.5 to 10 μm. The matting agent may be used singly or in combination of two or more thereof. In order to achieve a satisfactory transparency, the heat-sensitive recording material preferably has a refractive index ranging from 1.4 to 1.8. In order to improve color hues, the backing layer may include various dyes (e.g., C.I. Pigment Blue 60, C.I. Pigment Blue 64 or C.I Pigment Blue 15:6). The backing layer may also include a film hardener. Examples of the film hardener are described in “THE THEORY OF THE PHOTOGRAPHIC PROCESS, 4th edition” written by T. H. James, p.77-87, with vinyl sulfone compounds being preferable.

[Method for Producing Heat-sensitive Recording Material]

Hereinafter, a method for producing the heat-sensitive recording material of the invention will be explained.

The heat-sensitive recording material of the invention is produced by coating, on the substrate, the coating liquid for the heat-sensitive recording layer to form the heat-sensitive recording layer, followed by coating, on the thus produced heat-sensitive recording layer, the coating liquid for the protective layer to form the protective layer and further forming additional layers as necessary.

The heat-sensitive recording layer and the protective layer may be formed simultaneously, and in such a case, the coating liquid for the heat-sensitive recording layer and the liquid for the protective layer are coated together on the substrate to simultaneously form the heat-sensitive recording layer and the protective layer thereon.

The substrate used in this operation can be the substrate already explained in the foregoing as usable in the heat-sensitive recording material of the invention. Also the above-mentioned coating liquid for forming the heat-sensitive recording layer can be used for the heat-sensitive recording layer explained in the foregoing, and the above-mentioned coating liquid for forming the protective layer can also be used for the protective layer which contains the pigment and the binder as explained in the foregoing. Also the above-mentioned other layers such as the undercoat layer, the intermediate layer, the ultraviolet filter layer and the backing layer may be used as explained in the foregoing.

The heat-sensitive recording material of the invention may be produced by applying coating liquids by any method. More specifically, there can be employed various coating methods including extrusion coating, slide coating, curtain coating, knife coating, dip coating, flow coating or another type of extrusion coating utilizing a specific hopper described in U.S. Pat. No. 2,681,294. Preferably employable is extrusion coating described in “LIQUID FILM COATING” written by Stephen F. Kistler and Petert M. Schwaizer (CHAMPMAN & HALL, 1977) pp.399-536, or slide coating, with slide coating being more preferable. An example of the shape of the slide coater to be used in slide coating is shown in FIG. 11b.1 of this book, p.427. Also, if desired, two or more layers can be coated simultaneously by a method described in this book on pages 399 to 536 or by a method described in U.S. Pat. No. 2,761,791 and British Patent No. 837095. Drying can be performed by air-drying at a dry bulb temperature of 20 to 65° C., preferably 25 to 55° C. and at a wet bulb temperature of 10 to 30° C., preferably 15 to 25° C. In accordance with the method of the invention described above, the heat-sensitive recording material of the invention can be produced.

In the heat-sensitive recording material of the invention, the protective layer needs not necessarily be provided, and there may be included the heat-fusible substance relating to the invention in a region other than the protective layer. Examples of the heat-sensitive recording material not having the protective layer include a heat-sensitive recording paper provided only with the heat-sensitive recording layer on the substrate, for use in facsimiles or in POS labels. In such a case, the heat-fusible substance relating to the invention may be included in the heat-sensitive recording layer. In case where the heat-sensitive recording layer is made of plural layers developing different color hues, the heat-fusible substance relating to the invention may be included in the uppermost layer constituting the heat-sensitive recording layer. The heat-sensitive recording material not having the protective layer can also be produced by the producing method described above.

Thermal Head

The thermal head employed in the heat-sensitive recording method of the invention comprises a heating element having heat-generating resistance members and electrodes on a glaze layer, and is provided with a protective layer using a known film-forming apparatus to render its uppermost layer in contact with the heat-sensitive recording material to have a carbon content equal to or larger than 90%. The head protective layer may have two or more layers, but the carbon content should be 90% or higher in at least the uppermost layer.

The heat-sensitive recording material of the invention may include a specific heat-fusible substance in the protective layer. If the specific heat-fusible substance is included in the protective layer, problems of sticking or noises at the recording are unlikely to occur, and sufficient head matching can be obtained even with a thermal head that has an uppermost layer with a carbon content of 90% or higher and exhibits excellent resistance to abrasion, so that such a configuration can be advantageously applied to a field requiring high-quality images, such as medical uses.

### EXAMPLES

The present invention will be further described by the following examples, but it is to be understood that the invention is not limited to the examples. In the examples, “%” is all by mass unless otherwise specified.

### (Example 1)

[Preparation of Coating Liquid for Protective Layer]

(Preparation of Pigment Dispersion for Protective Layer)

To 110 g of water was added 30 g of stearic acid-processed aluminum hydroxide (trade name: Heijilite H42S, manufactured by Showa Denko Co., Ltd.) as a pigment, and after providing agitation for 3 hours, followed by addition of 0.8 g of an auxiliary dispersant (trade name: Poise 532A, manufactured by Kao Co.), 30 g of a 9.4% aqueous solution of polyvinyl alcohol (hereinafter referred to as PVA) (trade name: PVA105, manufactured by Kuraray Co.) and 10 g of a 2% aqueous solution of a compound represented by the following structural formula [1001], and the mixture was dispersed using a sand mill to thereby obtain a dispersion of the pigment for the protective layer, with an average particle size of 0.30 μm.

The “average particle size” was measured by dispersing the pigment in the presence of the auxiliary dispersant, then charging a test liquid, which had been prepared by diluting the pigment dispersion immediately after the dispersing operation by addition of water to reach 0.5%, into warm water of 40° C. so as to obtain a light transmittance of 75±1.0%, then subjecting to an ultrasonic treatment for 30 seconds. Measurement was conducted using a laser diffraction particle size distribution measuring apparatus (trade name: LA700, manufactured by Horiba Seisakusho Co., Ltd.). The average particle size of the pigment particles corresponding to 50% of the volume of the entire pigment was adopted, and the “average particle size” described hereinafter was all measured by the similar method.

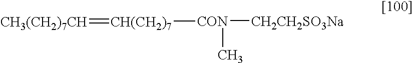

(Preparation of coating liquid for protective layer)

| To 65 g of water were added the following components to | | |
|---|---|---|
| prepare a coating liquid for the protective layer. | | |
| 8% aqueous solution of PVA | 90 | g |
| (trade name: PVA124C, manufactured by Kuraray Co.) | | |
| dispersion A to be described later | 12.9 | g |
| 4% aqueous solution of boric acid | 10 | g |
| pigment dispersion for protective layer described above | 61.6 | g |
| 35% aqueous dispersion of silicone oil | 5.0 | g |
| (trade name: BY22-840, manufactured by Toray-Dow Corning | | |
| Co.) | | |
| 10% aqueous solution of sodium dodecylbenzene-sulfonate | 6.5 | g |
| 75% solution of ammonium di-2-ethylhexylsulfosuccinate | 3.28 | g |
| (trade name: Nissan Electol SAL1, manufactured by Nippon | | |
| Oils and Fats Co.) | | |
| 6% aqueous solution of styrene/maleic acid copolymer | 17.5 | g |
| ammonium salt (trade name: Polymalon 385, manufactured by | | |
| Arakawa Kagaku Co., Ltd.) | | |
| 20% colloidal silica | 14 | g |
| (trade name: Snowtex, manufactured by Nissan Chemical Co., | | |
| Ltd.) | | |
| 10% aqueous solution of Surflong S131S | 16 | g |
| (manufactured by Asahi Glass Co., Ltd.) | | |
| Plysurf A217E | 1.1 | g |
| (manufactured by Dai-ichi Kogyo Seiyaku Co., Ltd.) | | |
| 2% acetic acid | 8 | g |

(Preparation of dispersion A)

| | | |
|---|---|---|
| To 61 g of water were added the following components. | | |
| 9.4% aqueous solution of PVA | 20 | g |
| (trade name: PVA 105, manufactured by Kuraray Co., Ltd.) | | |
| 2% aqueous solution of sodium dodecylbenzenesulfonate | 10 | g |
| glycerin tri-12-hydroxystearate | 20 | g |

The obtained mixture was dispersed using a sand mill to give an average particle size of 2 μm to thereby obtain a dispersion.

[Preparation of Coating Liquid for Heat-sensitive Recording Layer]

A microcapsule coating liquid that included an electron-donating dye precursor as the core material, and an emulsified dispersion of an electron-accepting compound were prepared in the following manner.

[Preparation of Microcapsule Liquid A]

To 24.3 g of ethyl acetate were added each of the compounds having the following structural formula [201] to [207] as the electron-donating dye precursor and after dissolution with heating to 70° C., the resultant solution was cooled to 45° C.

| | |
|---|---|
| compound of following structural formula [201] | 11.7 g |
| compound of following structural formula [202] | 1.5 g |
| compound of following structural formula [203] | 2.2 g |
| compound of following structural formula [204] | 5.65 g |
| compound of following structural formula [205] | 1.2 g |
| compound of following structural formula [206] | 1.1 g |
| compound of following structural formula [207] | 0.57 g |

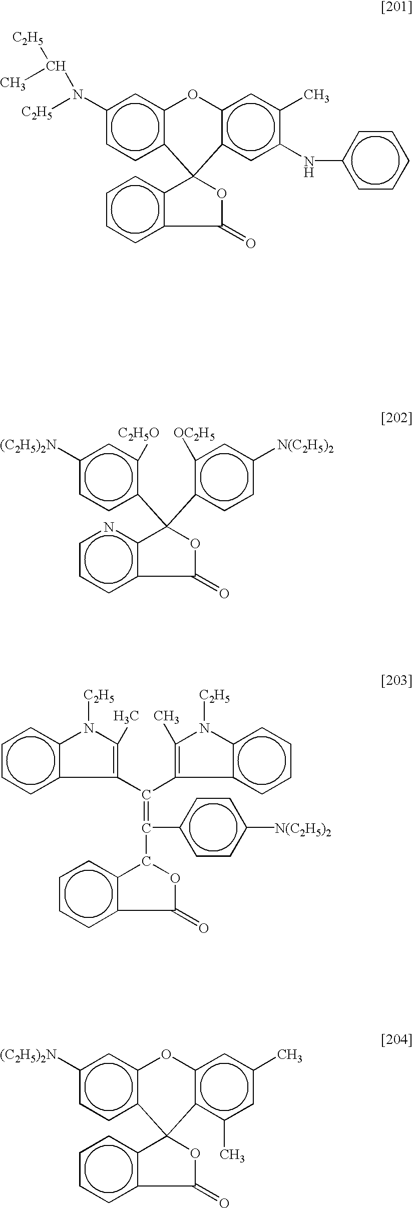

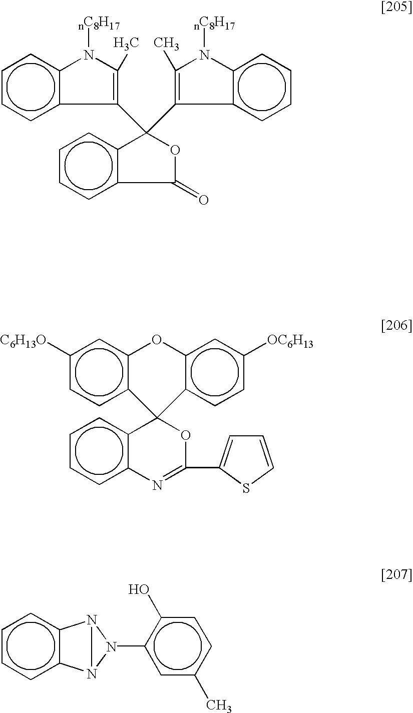

Then, 15.4 g of a capsule wall material (trade name: Takenate D 140N, manufactured by Takeda Pharmaceutical Industries Co., Ltd.) was admixed therewith.

The resultant solution was added to an aqueous phase that had been prepared by mixing 48 g of a 8% aqueous solution of PVA (trade name: MP-103, manufactured by Kuraray Co., Ltd.) with 16 g of water, and the obtained mixture was emulsified for 5 minutes at 15,000 rpm using an Ace Homogenizer (manufactured by Nihon Seild Co., Ltd.). To the thus produced emulsion was further added 110 g of water and 1.0 g of tetraethylene pentammine, after which an encapsulating reaction was effected to proceed for 4 hours at 60° C. to thus obtain a microcapsule liquid A with an average particle size of 0.8 μm.

(Preparation of Microcapsule Liquid B)

To 21 g of ethyl acetate were added the following components as the electron-donating dye precursor and after dissolution with heating to 70° C., the resultant solution was cooled to 45° C.

| | | |
|---|---|---|
| compound of the structural formula [201] | 12.2 | g |
| compound of the structural formula [202] | 1.6 | g |
| compound of the structural formula [203] | 2.4 | g |
| compound of the structural formula [204] | 3.3 | g |
| compound of the structural formula [205] | 1.5 | g |
| compound of the structural formula [206] | 0.2 | g |
| compound of the structural formula [207] | 0.5 | g |

Then, 16.6 g of a capsule wall material (trade name: Takenate D127N, manufactured by Takeda Pharmaceutical Industries Co., Ltd.) was admixed therewith.

The resultant solution was added to an aqueous phase that had been prepared by mixing 48 g of a 8% aqueous solution of PVA (trade name: MP-103, manufactured by Kuraray Co., Ltd.) with 16 g of water, and the obtained mixture was emulsified for 5 minutes at 15,000 rpm using an Ace Homogenizer (manufactured by Nihon Seiki Co., Ltd.). To the thus produced emulsion was further added 110 g of water and 1.0 g of tetraethylene pentammine, after which an encapsulating, reaction was effected to proceed for 4 hours at 60° C. to thus obtain a microcapsule liquid B with an average particle size of 0.3 μm.

(Preparation of Emulsified Dispersion of Electron-accepting Compound)

To 16.5 g of ethyl acetate were added each of the following components as the electron-accepting compound, together with 1.0 g of tricresyl phosphate and 0.5 g of diethyl maleate, and dissolved with heating at 70° C.

| | |
|---|---|
| compound of following structural formula [301] | 22.0 g |
| compound of following structural formula [302] | 80 g |
| compound of following structural formula [303] | 2.6 g |
| compound of following structural formula [304] | 2.6 g |
| compound of following structural formula [305] | 0.5 g |
| and as the ultraviolet absorbent: | |
| compound of following structural formula [306] | 4.0 g |

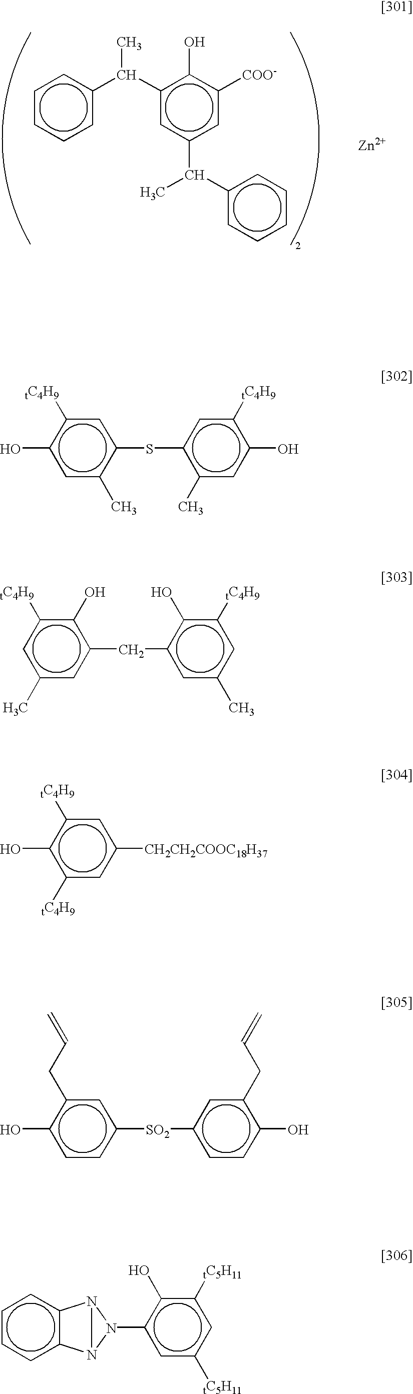

The resultant solution was added to an aqueous phase that had been prepared by mixing 67 g of water, 55 g of a 8% aqueous solution of PVA (trade name: PVA217C, manufactured by Kurarey Co., Ltd.), 19.5 g of a 15% aqueous solution of PVA (trade name: PVA205C, manufactured by Kuraray Co. Ltd.), 11 g of a 2% aqueous solution of a compound represented by the following structural formula [401] and 11 g of a 2% aqueous solution of a compound represented by the following structural formula [402]:,

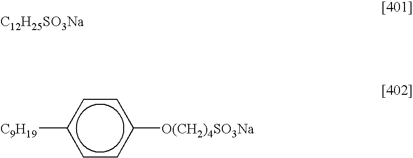

Then, the obtained mixture was emulsified at 10,000 rpm using an Ace Homogenizer (manufactured by Nihon Seiki Co., Ltd.) to obtain an average particle size of 0.7 μm, whereby an emulsified dispersion of the electron-accepting compound was obtained.

[Preparation of Coating Liquid A for Heat-sensitive Recording Layer]

24 g of the microcapsule liquid A (solid content: 23%), 55 g of the microcapsule liquid B (solid content: 24%), 100 g of the emulsified dispersion of the electron-accepting compound (solid content: 22%), 1.3 g of a 50% aqueous solution of a compound represented by the following structural formula [403 ], 3.6 g of colloidal silica (trade name: Snowtex, manufactured by Nissan Chemical Co., Ltd.) and 6.7 g of water were admixed to obtain a coating liquid A for the heat-sensitive recording layer.

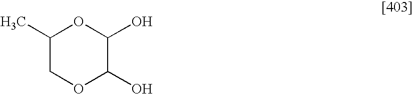

[Preparation of Coating Liquid B for Heat-sensitive Recording Layer]

The following components were admixed to prepare a coating liquid B for the intermediate layer.

| | | |
|---|---|---|
| microcapsule liquid A (solid content: 23%) described above | 12.5 | g |
| microcapsule liquid B (solid content: 24%) described above | 14.5 | g |
| emulsified dispersion of the electron-accepting compound | 100 | g |
| described above (solid content: 22%) | | |
| 50% aqueous solution of a compound represented by the | 1.2 | g |
| structural formula [403] | | |
| colloidal silica | 4.5 | g |
| (trade name: Snowtex, manufactured by Nissan Chemical Co., | | |
| Ltd.) | | |
| water | 14.5 | g |

[Preparation of Coating Liquid for Intermediate Layer]

To 1 kg of lime-processed gelatin was added 7848 g of water and dissolved therein, followed by further addition of 137 g of a 5% solution (in a ratio of water/methanol=1/1 by volume) of sodium di-2-ethylhexylsulfosuccinate (trade name: Nissan Rapizol B90, manufactured by Nippon Oils and Fats Co., Ltd.) to obtain a coating liquid for the intermediate layer.

[Preparation of Coating Liquid A for Backing Layer]

1 kg of lime-processed gelatin, 757 g of a dispersion of gelatin containing 12% of spherical PMMA particles having an average particle size of 5.7 μm, and 3761 g of an emulsion of ultraviolet absorbents including compounds represented by the structural formulas [501] to [505] in the following amounts (represented by the content of the ultraviolet absorbent per kilogram of the emulsion) were admixed, to which was added water to finally give a total amount of 57.1 liters of a mixture.

| | | |
|---|---|---|
| compound of structural formula [501] | 9.8 | g |
| compound of structural formula [502] | 8.4 | g |
| compound of structural formula [503] | 9.8 | g |
| compound of structural formula [504] | 13.98 | g |
| compound of structural formula [505] | 29.3 | g |
| 1,2-benzisothiazolin-3-one | 1.75 | g |
| poly(sodium p-vinylbenzenesulfonate) | 64.2 | g |
| (molecular weight about 400,000) | | |
| compound of structural formula [506] | 15.0 | g |
| 20% latex solution of polyethyl acrylate | 3,180 | mL |
| N,N-ethylene-bis(Vinylsulfonyl acetamide) | 75.0 | g |
| 1,3-bis(vinylsulfonyl acetamide)propane | 25.0 | g |

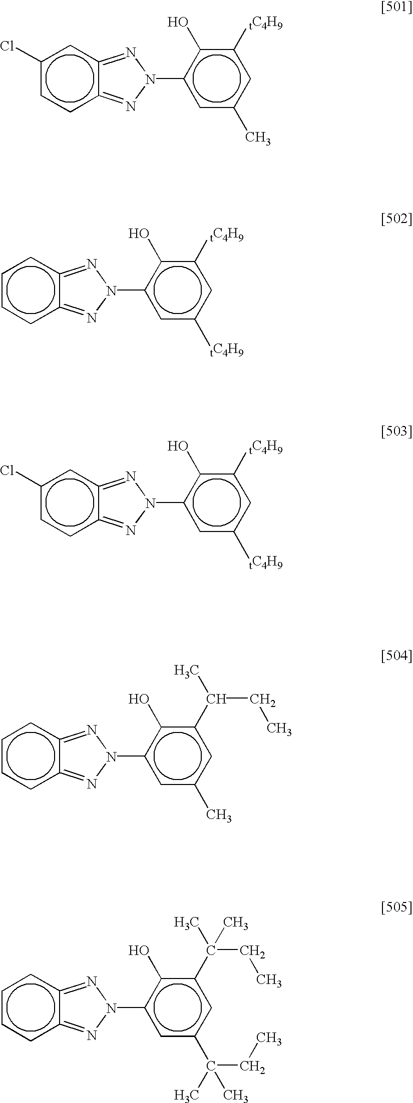

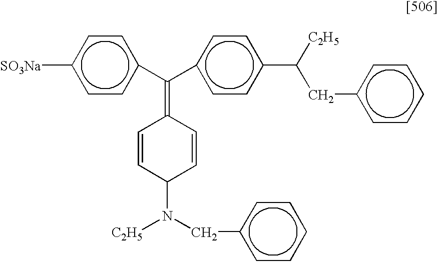

[Preparation of Coating Liquid B for Backing Layer]

1 kg of lime-processed gelatin, 2000 g of a dispersion of gelatin containing 12% of spherical PMMA particles having an average particle size of 0.70 μm, 1268 ml of methanol, 1.75 g of 1, 2-benzisothiazolin-3-one, 64.4 g of sodium polyacrylate (molecular weight about 100,000), 54.0 g of poly(sodium p-binylbenzenesulfonate) (molecular weight about 400,000), 25.2 g of sodium p-t-octylphenoxy-polyoxyethylene-ethylsulfonate, 5.3 g of sodium N-propyl-N-polyoxyethylene-perfluorooctanesulfonic acid amide butyl-sulfonate, and 7.1 g of potassium perfluorooctanesulfonate were admixed to have a pH of 7.0 with sodium hydroxide, to which was added water to finally give a total amount of 66.79 liters of a mixture.

[Preparation of Heat-sensitive Recording Material]

(Preparation of Backing Layer)

On one surface of a biaxially oriented polyethylene terepthalate substrate having a thickness of 180 μm, which had blue color defined by X=0.2850 and Y=0.2995 in chromaticity coordinates using a method standardized by JIS-Z8701, were applied the coating liquid A for the backing layer and the coating liquid B for the backing layer in this order from the substrate and dried simultaneously by a slide bead method so as to obtain respective coating amounts of 40 mL/m² and 18.5 mL/m². The conditions for coating and drying were as follows. The coating speed was specified as 160 m/min, with a gap of 0.10 to 0.30 mm between the front end of a coating die and the substrate, and a pressure was adjusted to have reduced pressure lower by 200 to 1000 Pa than the atmospheric pressure. The substrate was charge-eliminated with an ionized air before coating. In a subsequent chilling zone, the coating liquids were cooled with an air at a dry-bulb temperature of 0 to 20° C. and the substrate was conveyed in non-contact state and dried in a helical non-contact drying apparatus with a drying air at a dry-bulb temperature of 23 to 45° C. and at a wet-bulb temperature of 15 to 21° C.

(Preparation of Heat-sensitive Recording Layer)

On a surface opposite to the backing layer of the substrate provided with the backing layer, the coating liquid A for the heat-sensitive recording layer, the coating liquid B for the heat-sensitive recording layer, the coating liquid for the intermediate layer and the coating liquid for the protective layer were successively coated in this order from the substrate and dried simultaneously by a slide bead method so as to obtain respective coating amounts of 50 mL/m², 20 mL/m², 18.2 mL/m² and 26.2 mL/m², whereby a transparent heat-sensitive recording material of the invention having the heat-sensitive recording layer A, the heat-sensitive recording layer B, the intermediate layer and the protective layer in the order from the substrate was produced. The temperature of the coating liquids for the respective layers was controlled in a range of 33 to 37° C. The drying conditions were as follows. The coating speed was specified as 160 m/min, with a gap of 0.10 to 0.30 μm between the front end of the coating die and the substrate, and a pressure was adjusted to have reduced pressure lower by 200 to 1000 Pa than the atmospheric pressure. The substrate was charge-eliminated with an ionized air before coating. In a subsequent initial drying zone, drying was conducted with an air of 45 to 55° C. and a dew point of 0 to 5° C., and the substrate was conveyed in non-contact state, then dried in a helical non-contact drying apparatus with a drying air at a dry-bulb temperature of 30 to 45° C. and at a wet-bulb temperature of 17 to 23° C., and after the drying, subjected to humidity adjustment at a humidity of 40 to 60% at 25° C.

Evaluation of Whitening

The produced heat-sensitive recording material was subjected to recording with a thermal head (trade name: KGT, 260-12MPH8, manufactured by Kyocera Co., Ltd.) employing a head pressure of 10 kg/cm² and a recording energy of 110 mJ/mm², and 1 hour after the recording, the surface of the heat-sensitive recording material was rubbed with a finger and the level of whitening was evaluated by visual observation. The results were evaluated as “+” in case where no smearing was found, “±” in case where slight smearing was found but within a permissible level, and “−” in case where excessive smearing was clearly found with deterioration of quality. The results of evaluation are shown in Table 1.

<Evaluation of Sticking>

The produced heat-sensitive recording material was subjected to recording with a thermal head (trade name: KGT, 260-12MPH8, manufactured by Kyocera Co., Ltd.) employing a head pressure of 10 kg/cm² and a recording energy of 110 mJ/mm², and the surface of the heat-sensitive recording material was observed visually under a magnifying loupe. The results were evaluated as “+” in case where no sticking was found, “±” in case where some sticking was observed under the loupe and may constitute a practical problem, and “−” in case where sticking was clearly observed visually and may constitute a practical problem. The results of evaluation are shown in Table 1.

(Example 2)

A heat-sensitive recording material was produced in the same manner as in Example 1, except that the dispersion A used in the preparation of the coating liquid for the protective layer in Example 1 was replaced with 12.9 g of a dispersion which was prepared by mixing the following components and had an average particle size of 2 μm using a sand mill.

| | |
|---|---|
| water | 61 g |
| 9.4% aqueous solution of PVA | 20 g |
| (trade name: PVA 105, manufactured by Kuraray Co., Ltd.) | |
| 2% aqueous solution of sodium dodecylbenzenesulfonate | 10 g |
| 12-hydroxystearic acid amide | 20 g |

The obtained heat-sensitive recording material was evaluated in the same manner as in Example 1.

(Example 3)

A heat-sensitive recording material was produced in the same manner as in Example 1, except that the dispersion A used in the preparation of the coating liquid for the protective layer in Example 1 was replaced with 12.9 g of a dispersion which was prepared by mixing the following components and had an average particle size of 2 μm using a sand mill.

| | |
|---|---|
| water | 61 g |
| 9.4% aqueous solution of PVA | 20 g |
| (trade name: PVA 105, manufactured by Kuraray Co., Ltd.) | |
| 2% aqueous solution of sodium dodecylbenzenesulfonate | 10 g |
| 12-hydroxystearic acid | 20 g |

The obtained heat-sensitive recording material was evaluated in the same manner as in Example 1.

### Comparative Example 1

A heat-sensitive recording material was produced in the same manner as in Example 1, except that the dispersion A used in the preparation of the coating liquid for the protective layer in Example 1 was replaced with 12.9 g of a dispersion which was prepared by mixing the following components and had an average particle size of 2 μm using a sand mill.

| | |
|---|---|
| water | 61 g |
| 9.4% aqueous solution of PVA | 20 g |
| (trade name: PVA 105, manufactured by Kuraray Co., Ltd.) | |
| 2% aqueous solution of sodium dodecylbenzenesulfonate | 10 g |
| stearic acid amide | 20 g |

The obtained heat-sensitive recording material was evaluated in the same manner as in Example 1.

### Comparative Example 2

A heat-sensitive recording material was produced in the same manner as in Example 1, except that the dispersion A used in the preparation of the coating liquid for the protective layer in Example 1 was replaced with 12.9 g of a dispersion which was prepared by mixing the following components and had an average particle size of 2 μm using a sand mill.

| | |
|---|---|
| water | 61 g |
| 9.4% aqueous solution of PVA | 20 g |
| (trade name: PVA 105, manufactured by Kuraray Co., Ltd.) | |
| 2% aqueous solution of sodium dodecylbenzenesulfonate | 10 g |
| zinc stearate | 20 g |

The obtained heat-sensitive recording material was evaluated in the same manner as in Example 1.

### Comparative Example 3

A heat-sensitive recording material was produced in the same manner as in Example 1, except that the dispersion A used in the preparation of the coating liquid for the protective layer in Example 1 was replaced with 12.9 g of a dispersion which was prepared by mixing the following components and had an average particle size of 2 μm using a sand mill.

| | |
|---|---|
| water | 61 g |
| 9.4% aqueous solution of PVA | 20 g |
| (trade name: PVA 105, manufactured by Kuraray Co., Ltd.) | |
| 2% aqueous solution of sodium dodecylbenzenesulfonate | 10 g |
| stearic acid | 20 g |

The obtained heat-sensitive recording material was evaluated in the same manner as in Example 1.

TABLE 1

| | Lubricant | Whitening | Sticking |
|---|---|---|---|
| Example 1 | glycerin tri-12-hydroxystearate | + | + |
| Example 2 | 12-hydroxystearic acid amide | + | + |
| Example 3 | 12-hydroxystearic acid | + | ± |
| Comp. Ex. 1 | Stearic acid amide | − | + |
| Comp. Ex. 2 | Zinc stearate | − | − |
| Comp. Ex. 3 | Stearic acid | + | − |

<Whitening>
+: no smearing
±: slight smearing but within permissible level
−: excessive smearing with deterioration of quality
<Sticking>
+: no sticking
±: some sticking observable under loupe, and possibly constituting a problem
−: sticking clearly observed visually and constituting a practical problem.

The results in Table 1 reveal that the heat-sensitive recording materials obtained in Examples did not induce whitening and sticking phenomena, but the heat-sensitive recording materials obtained in Comparative Examples were found impossible to prevent whitening and sticking at the, same time.

As detailed above, the present invention provides a heat-sensitive recording material which exhibits excellent head matching. The invention also provides a heat-sensitive recording material that can exhibit sufficient head matching to a thermal head that has a surface layer principally composed of carbon to exert excellent resistance to abrasion. Furthermore, the invention provides a heat-sensitive recording material that can form high-quality images without inducing any surface-whitening phenomena after the recording.

What is claimed is:

1. A heat-sensitive recording material comprising, as a heat-fusible substance, a derivative of a higher fatty acid in which one or more hydrogen atoms in an alkyl group are replaced with hydroxyl groups.

2. The heat-sensitive recording material according to claim 1, wherein the derivative of the higher fatty acid in which one or more hydrogen atoms in an alkyl group are replaced with hydroxyl groups is a derivative of 12-hydroxystearic acid.

3. The heat-sensitive recording material according to claim 2, wherein the derivative of 12-hydroxystearic acid is selected from the group consisting of 12-hydroxystearic acid, a metal salt of 12-hydroxystearic acid, an amide compound of 12-hydroxystearic acid and an ester of 12-hydroxystearic acid.

4. The heat-sensitive recording material according to claim 3, wherein the ester of 12-hydroxystearic acid is an esterified product of 12-hydroxystearic acid and a polyhydric alcohol.

5. The heat-sensitive recording material according to claim 4, wherein the esterified product of 12-hydroxystearic acid and a polyhydric alcohol is glycerin 12-hydroxystearate.

6. A heat-sensitive recording material comprising a substrate having disposed thereon a heat-sensitive recording layer and a protective layer including a pigment and, as a heat-fusible substance, a derivative of a higher fatty acid in which one or more hydrogen atoms in an alkyl group are replaced with hydroxyl groups.

7. The heat-sensitive recording material according to claim 6, wherein the derivative of the higher fatty acid in which one or more hydrogen atoms in an alkyl group are replaced with hydroxyl groups is a derivative of 12-hydroxystearic acid.

8. The heat-sensitive recording material according to claim 7, wherein the derivative of 12-hydroxystearic acid is selected from the group consisting of 12-hydroxystearic acid, a metal salt of 12-hydroxystearic acid, an amide compound of 12-hydroxystearic acid and an ester of 12-hydroxystearic acid.

9. The heat-sensitive recording material according to claim 6, wherein the pigment has a 50% volume-average particle size of 0.10 to 5.0 μm.

10. The heat-sensitive recording material according to claim 9, wherein the pigment is selected from the group consisting of calcium carbonate, titanium oxide, kaolin, aluminum hydroxide, amorphous silica, zinc oxide, urea-formalin resin and epoxy resin.

11. The heat-sensitive recording material according to claim 6, wherein the heat-sensitive recording layer contains a combination of an electron-donating dye precursor and an electron-accepting compound.

12. The heat-sensitive recording material according to claim 11, wherein the electron-donating dye precursor is selected from the group consisting of a triphenylmethane phthalide-based compound, a fluoran-based compound, a phenothiazine-based compound, an indolyl phthalide-based compound, a leuco auramine-based compound, a rhodamine lactam-based compound, a triphenylmethane-based compound, a triazene-based compound, a spiropyran-based compound, a fluorene-based compound, a pyridine-based compound and a pyrazine-based compound.

13. The heat-sensitive recording material according to claim 11, wherein the electron-accepting compound is selected from the group consisting of a phenol compound, an organic acid or the metal salt thereof, and an oxybenzoic acid ester.

14. The heat-sensitive recording material according to claim 12, wherein the electron-donating dye precursor is contained in an amount of 0.1 to 5.0 g/m² of the heat-sensitive recording layer.

15. The heat-sensitive recording material according to claim 6, wherein the heat-sensitive recording layer contains a combination of a photodegradable diazo compound and a coupler.

16. The heat-sensitive recording material according to claim 15, wherein the photodegradable diazo compound is selected from the group consisting of an aromatic diazonium salt, a diazosulfonate compound and a diazoamino compound.

17. The heat-sensitive recording material according to claim 16, wherein the photodegradable diazo compound is contained in an amount of 0.02 to 5.0 g/m² of the heat-sensitive recording layer.

18. The heat-sensitive recording material according to claim 6, wherein the heat-sensitive recording layer contains an ultraviolet absorbent selected from the group consisting of a benzophenone-based ultraviolet absorbent, a benzotriazole-based ultraviolet absorbent, a salicylic acid-based ultraviolet absorbent, a cyanoacrylate-based ultraviolet absorbent and an oxalic acid anilide-based ultraviolet absorbent.

19. A heat-sensitive recording method comprising applying thermal energy via a thermal head having an uppermost layer whose carbon content is 90% or higher, to a heat-sensitive recording material containing as a heat-fusible substance a derivative of a higher fatty acid in which one or more hydrogen atoms in an alkyl group are replaced with hydroxyl groups.

20. The heat-sensitive recording method according to claim 19, wherein the amount of thermal energy applied ranges from 90 to 150 mJ/mm².
